(19) United States
(12) Patent Application Publication
(10) Pub. No.: US 2012/0246048 A1
(43) Pub. Date: Sep. 27, 2012

(54) Cross-Sectional Economic Modeling and Forward Looking Odds

(76) Inventors: Michael Cohen, Denver, CO (US); Chenyang Lian, Richmond, CA (US); Andrew Leverentz, San Francisco, CA (US); Frederic Huynh, Novato, CA (US); Erik Franco, Napa, CA (US); Gary Sullivan, San Francisco, CA (US); Jeffrey Feinstein, Atlanta, GA (US); Hui Zhu, Boston, MA (US); Chetan Bhat, San Diego, CA (US)

(21) Appl. No.: 13/430,359

(22) Filed: Mar. 26, 2012

Related U.S. Application Data
(60) Provisional application No. 61/467,909, filed on Mar. 25, 2011.

(51) Int. Cl. G06Q 40/00

(52) U.S. Cl. 705/35

(57) ABSTRACT

A cross-sectional model is provided that determines the relationship between macroeconomic factors and the odds to score relationship of a scoring model. The cross-sectional model takes economic data from various economic regions, as opposed to time periods, as input, and produces, as output, a prediction of the curve-of-best fit that relates a score to a probability (i.e., the probability of the outcome in question such as paying back a loan or filing an insurance claim, etc.). Related systems, methods and articles are also described.

### CROSS-REFERENCE TO RELATED APPLICATION

This application claims the benefit of U.S. Provisional Application No. 61/467,909, filed on Mar. 25, 2011, the contents of which are fully incorporated herein by reference.

### BACKGROUND

1. Field

The present subject matter generally relates to predictive economic model development. More particularly, the present subject matter relates to generating a cross-sectional model to predict changes in the relationship between a score (such as a credit score) and subsequent observed outcomes, which may be used as a tool in decision making.

2. Background Information

Decision Makers (lenders, insurers, marketers) often use scores as a rank ordering tool to decide which consumers/accounts to take actions on. These scores have a log-linear relationship with the odds of the desired outcome, expressed as:

Ln (odds)=ms+k;
where s is a score, m is a scope, and k is an intercept.

Due to changes in the external environment (competitors, economics, regulatory, etc), this odds to score relationship can change over time:

Ln (odds)=mₜs+k,

As can be seen in FIG. 10, when the log odds to score relationship changes over time, a new cut-off score (e.g. a minimum score required by the decision maker such that accounts above the score are accepted and accounts below the score are rejected) is needed to correspond to the same desired odds. Decision makers desire a score that has a stable log odds to score relationship over time, so that they do not need to change policy (scores at which they take actions) in order to adapt to changes to the odds to score relationship over time. There are many policies in many decision areas where scores are used, so this consistency is desirable to ensure that issuers do not have to continually have to change polices as the odds to score relationship changes.

Stated differently, decision makers desire a score with an odds to score relationship that is not impacted by changes to the external marketplace. One way to create such a score is to start with a base score, such as the FICO score, which is the existing/original score. This score may be impacted by market conditions such that the odds to score relationship of this score changes over time, which is undesirable. The modified score (as provided herein) is a score similar to the original score that has all of the predictive power of the original score, but with the added benefit of a stable log odds to score relationship over time.

Typically, one would attempt to model this odds to score relationship change against macroeconomic factors by building longitudinal time-series models. However, this can be challenging due to historical data availability, and it can be difficult to include changes to the regulatory and competitive environment in such models. Even if there is sufficient data available, collection of this large amount of data can be expensive. Further, storage of this large amount of data is expensive, as large amounts of memory/data-storage may be required. Furthermore, the large amount of data can consume significant computing resources.

### BRIEF SUMMARY

Different micro-geographic areas have different economic conditions; as such, one can use the economic conditions in each geographic area as a proxy for the differences in the national economy over time. By using this data as a proxy, one can successfully build models relating macroeconomic conditions to the odds to score relationship. In other words, micro-geographies and their differing economic conditions are used to proxy changes over time to economic conditions. This approach is referred to herein as cross-sectional modeling. Importantly, this approach requires observation data from only one point in time, rather than the several years worth of data that would be required for typical time-series modeling.

Implementations of the present subject matter may include, for example:
Generating statistical models that show how the slope and intercept changes with respect to the economy (e.g. based on various economic data).
Adjusting scores based on economic conditions, such that their odds to score relationship is stable over time.

In one aspect, a computer-implemented method of predicting a risk indicator that is stable over time is provided. The method is implemented by one or more data processors, and includes receiving, by at least one data processor, data representing a credit risk score and a credit report, the credit report comprising a plurality of prediction characteristics used to determine creditworthiness of an individual; inputting, by at least one data processor to a predictive model, the received data; and outputting, by at least one data processor, from the predictive model based on the received data, a risk indicator.

The predictive model can be generated by storing available historical data for combinations of a plurality of regions and dates, the available historical data including macroeconomic data and credit performance data; building the model based on the available historical data; and determining a translation and/or rotation of the predictive model associated with the combinations of the regions and dates based on the built mode.

The method can further include, adjusting, by at least one data processor, the predictive model using selected economic data from the available historical data and determining a new translation and/or rotation of the predictive model associated with the selected economic data.

The method can also further include adjusting the risk indicator based on the one or more factors selected from the group including: a type of load, one or more marketing policies, one or more underwriting criteria, a portfolio sourcing, a customer sourcing, one or more collection practices, a competition, geographic, and the economy.

The risk indicator outputted by the predictive model can be

ln (odds)=m(\vec{e})*score+k(\vec{e})

where m(\vec{e}) is a model giving the rotation (slope) under economic conditions \vec{e}, and k(\vec{e}) is a model for translation (intercept) under the economic conditions \vec{e}.

The predictive model can be represented by

newScore=(m(e)/m₀)*existingScore+(k(e)−k₀)/m₀

where m(\vec{e}) is a model giving the rotation (slope) under economic conditions \vec{e}, and k(\vec{e}) is a model for translation (intercept) under the economic conditions \vec{e}., and newScore is the risk indicator having a constant odds to score relationship.

The method can include deciding, by at least one data processor, whether the risk indicator meets a minimum requirement.

The building of the model can include using least-squares linear regression or time-series techniques.

The method can further include inputting to the predictive model, a risk region of the risk being assessed, wherein the risk indicator outputted by the predictive model is based on the available economic data relevant to the risk region.

In a further aspect, a computer-implemented method of generating and implementing a model to predict changes in a relationship between a credit score and subsequent observed outcomes is provided. The method is implemented by one or more data processors and includes storing available historical data for combinations of a plurality of regions and dates, the available historical data including macroeconomic data and credit performance data; building the model based on the available historical data; and determining a translation and/or rotation of the predictive model associated with the combinations of the regions and dates based on the built model.

In another further aspect, a system for producing a risk indicator that is stable over time is provided. The system includes a computing device, which includes a processing component and a storage component; and computer-readable instructions residing in the storage component which, when executed by the processing component instruct the processor to perform operations including: receiving data representing a credit risk score and a credit report, the credit report including a plurality of prediction characteristics used to determine creditworthiness of an individual; inputting to a predictive model the received data; and outputting from the predictive model based on the received data, a risk indicator. The predictive model can be generated by storing available historical data for combinations of a plurality of regions and dates, the available historical data including macroeconomic data and credit performance data; building the model based on the available historical data; and determining a translation and/or rotation of the predictive model associated with the combinations of the regions and dates based on the built model.

Articles of manufacture are also described that comprise computer executable instructions permanently stored on computer readable media, which, when executed by a computer, causes the computer to perform operations herein. Similarly, computer systems are also described that can include a processor and a memory coupled to the processor. The memory can temporarily or permanently store one or more programs that cause the processor to perform one or more of the operations described herein. Method operations can be implemented by one or more data processors within a single computing system or distributed across two or more computing systems.

The approach described herein provides many advantages. For example, the cross-sectional model determines odds versus score relationship based on economic variables while using an amount of data that is significantly less than an amount of data used by conventional techniques (only one time frame as opposed to several years worth of data), thereby reducing expenses related with collection, storage and processing of large amounts of data (which in turn optimizes the use of computing resources).

The details of one or more variations of the subject matter described herein are set forth in the accompanying drawings and the description below. Other features and advantages of the subject matter described herein will be apparent from the description and drawing, and from the claims.

### BRIEF DESCRIPTION OF DRAWING

FIG. 1 is a plot of default rates of different loan types based on credit scores;

FIG. 2 is a plot of mortgage default/delinquency rates in different economic conditions based on credit scores;

FIG. 3 is a plot of mortgage default rates by date and by region based on credit scores;

FIG. 4 is a plot showing a linear relationship between the default odds and credit scores;

FIG. 5 is a plot of the intercept “k” (intercept of the ln (odds) to score relationship) showing the variations over time with respect to a particular consumer arrangement;

FIG. 6 is a plot showing the relationship between economic factors (GDP growth rate) and the intercept “k” (intercept of the ln (odds) to score relationship) over time;

FIG. 7 illustrates a relationship between economic factors (Interest rate) and the intercept “k(\vec{e})” (intercept of the ln (odds) to score relationship) over time;

FIG. 8 is a plot showing the estimated versus predicted default rates in the period between Q2 of 2002 to Q2 of 2006;

FIG. 9A is a graphical illustration of a constant economic behavior in a stationary way to estimate future economy in accordance with some implementations of the current subject matter;

FIG. 9B is a graphical illustration of an economy that continues on path that it has been on;

FIG. 9C is a graphical illustration of an economy that changes the path that it has been on;

FIG. 10 is an illustration showing that a new cut-off score is needed when the odds to score relationship is not stable over time;

FIG. 11 is a flowchart illustrating a method according to the subject matter.

FIG. 12 is a flowchart illustrating steps for determining historical performance data according to the subject matter.

### DETAILED DESCRIPTION

There are many situations in which it would be desirable for a decision maker to use a scoring algorithm to guide decisions that must be made individually for a large number of customers. Different customers exhibit different outcomes in response to events such as obtaining loans, in response to certain insurance premium levels, etc. While the current description is focused on the likelihood of a customer paying back a loan, it will be appreciated that the underlying techniques can be applied for many different situations.

With regard to the loan example, the probability/likelihood of different customers to pay back a loan can be different. The payback of a loan can depend on various factors, such as a credit profile of a customer. The loan providers, which are also referred herein as the decision-makers, often use scoring algorithms to rank-order customers according to their likelihood of exhibiting certain outcomes, such as their probability of defaulting on a loan. These decision-makers may be, for example, banks, insurers, loan-providing companies, loan-providing individuals, and other like entities. The lenders can desire to rank order credit applicants by a corresponding risk of credit default, that is, rank order credit applicants by their likelihood of defaulting on at least one loan. In one implementation, the default on a loan can be considered if a customer defaults for subsequent predetermined number (e.g. “N”) of months.

The likelihood of default can be calculated by a scoring algorithm, which can be represented, for example, by a mathematical function. The input to the mathematical function may includes, for example, known attributes for a given customer, such as credit history, current account balance, past account balance at different times, default history, current and past lines of credit, and the like. The output of the mathematical function is typically a number, which is referred to as a score corresponding to a particular customer. The score can be limited to a fixed range of values. Some decision-makers may desire a translation of the output of a scoring algorithm into probabilities, which may be readily incorporated into business forecasts. A probability associated with a customer can correspond to a particular score of a customer. For instance, if a decision-maker/lender believes, based on past experience, that a particular score value (e.g. “X”) of a customer corresponds, on average, to a particular probability (e.g. “P”) of defaulting on one or more loans, then that information can be used in calculating expected losses for the customer. While some of the current description describes forecasting based on individual customers, it will be appreciated that individual customers can be aggregated into groups and forecasting may be provided for such groups.

The scoring algorithm can be based on a variety of statistical techniques, such as logistic regression, neural networks, or FICO's proprietary scorecard technology. These statistical techniques can be designed to create a function that maps (i) customer profiles exhibiting higher likelihoods for the outcome in question to values farther toward one end of the fixed range of values, and (ii) customer profiles exhibiting lower likelihoods to values farther toward the opposite end of the fixed range of values. Thus, customers having a high probability/likelihood of paying back a loan can have a high score while customers having a low probability/likelihood of paying back a loan can have a low score. In other implementations, customers having a high probability/likelihood of paying back a loan can have a low score while customers having a low probability/likelihood of paying back a loan can have a high score.

The statistical techniques, such as logistic regression, neural networks, or scorecard technology, as mentioned above produce a scoring algorithms to take as input the customer attributes and produce a score.

Some scoring tools can provide a rank ordering of risk. Credit score (e.g. FICO® score) can be based on information in a credit bureau report of a consumer. The credit score can be designed to rank-order risk for different lending products. The rank ordering holds true regardless of the lending product, which implies that higher scores indicate lower risk for each product. Thus, the score can indicate a relative (e.g. higher or lower) risk.

It should be noted that this rank ordering does not provide a specific risk estimate, for example, a particular probability P of the scored consumer defaulting on a loan; rather the rank ordering merely means that consumers with higher scores will have a lower probability of default than consumers with lower scores.

However, it can be advantageous for lenders to obtain a specific estimate, as opposed to a relative estimate, of risk that corresponds to each score. The specific estimate of risk, which can also be referred to as absolute risk, can be characterized by factors, including but not limited to those noted below:

Type of Loan:

Credit card, auto, mortgage, ARM mortgage versus 30-year fixed mortgage, etc.

Marketing Policies:

As targeting strategy of a lender changes, the applicant population can change.

Underwriting Criteria:

Amount of documentation required, debt to income thresholds, etc.

Portfolio Sourcing:

Direct versus indirect auto lending.

Customer Sourcing:

Internet versus Bank branch.

Collection Practices:

Ability of a lender to identify and quickly interact with customers at risk of default.

Competition:

As consumers are presented with more (or less) attractive offers by the competition, attrition can change the scoring population.

Geography:

By FDIC region, state, even for different areas within a state.

The Economy:
Macroeconomic factors, etc.
Consumers' ability to repay changes as the economy shifts.
“Good” consumers may retain the ability to refinance in downturns, leaving behind a portfolio of riskier consumers.

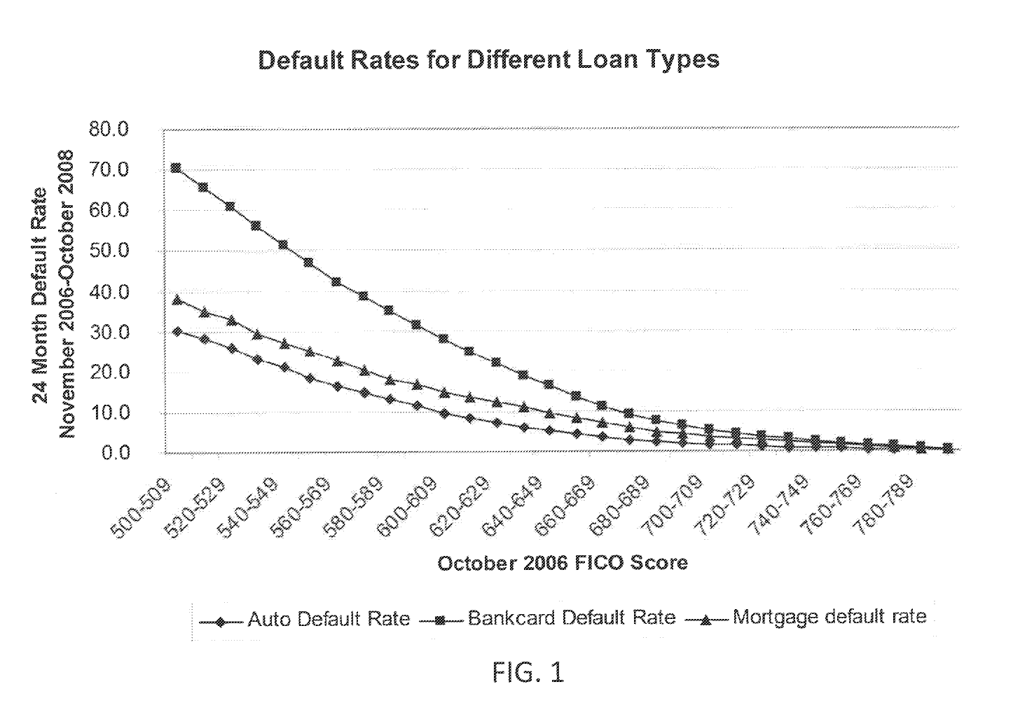

FIG. 1 illustrates how default rates can vary by loan types. As can be seen, the default rates of different loan products (e.g. auto, bankcards, mortgages) from accounts having the same credit scores (e.g. FICO® score) in the 24 month period from November 2006 to October 2008 are different for different loan products.

For a loan product, underwriting policy can impact risk by looking at a case of full-doc loans versus a case of no-doc loans. A full-doc loan typically refers to a loan where all income and assets are documented. For example, a full-doe loan can be provided based on proof of earnings (W-2 form, pay stubs, tax returns, and profit and loss statements), social security, overtime bonus, commission, passive income, and the like. A full-doc loan is a common type of loan used for financing a home purchase. With respect to full-doc loans, there is more information about income and capacity of the borrower/consumer to repay, thereby giving the lender a better understanding of the likelihood that a consumer will be able to make payments associated with the loan. A no-doc loan may not have documentation for income and assets, as with a full-doc loan. With no-doc loans, there is a higher likelihood that a consumer is misreporting income or other information, which may lead to a higher likelihood of default with the same FICO® score.

Further, targeting can impact risk associated with a lending product. For instance, there can be a different risk associated with consumers that opened an adjustable rate mortgage (ARM) with the intention of refinancing before the ARM reset and consumers that opened fixed-rate loans. Given the difficulty that some consumers can have with refinancing, the consumers who opened ARMs can have greater risk than consumers, which are associated with the same score and which obtained fixed-rate loans.

Changing economic conditions can also have a large impact on the risk levels observed at each score level. As the credit scores are based only on information available through credit bureaus, which does not include any kind of macroeconomic information, the risk levels associated with a credit score can vary under different economic conditions.

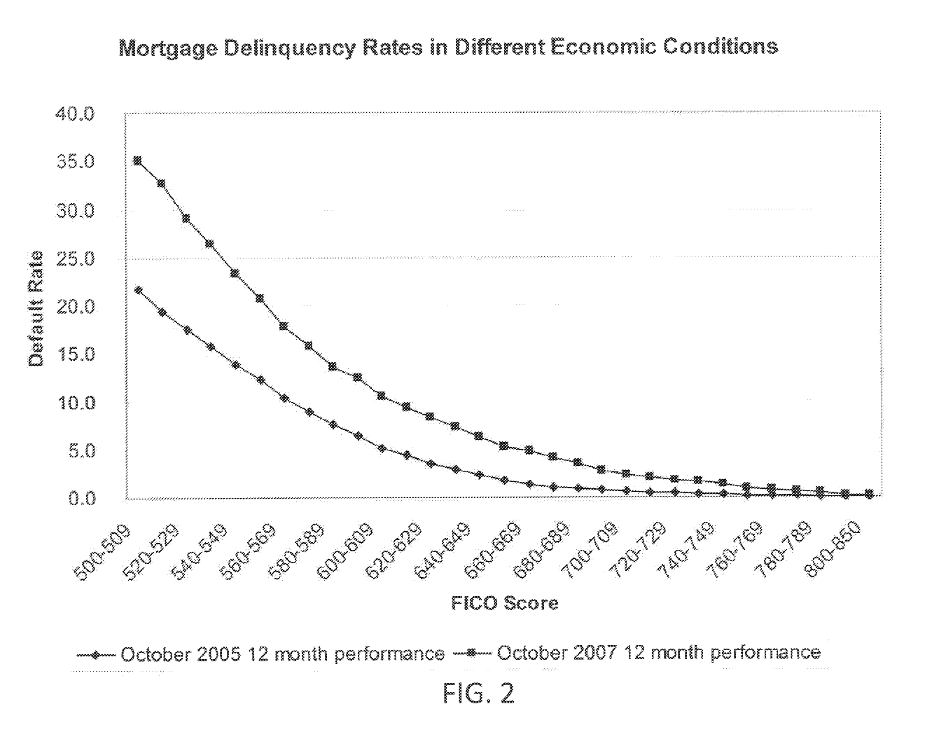

FIG. 2 illustrates mortgage default/delinquency rates in different economic conditions. The delinquency rates are plotted by date.

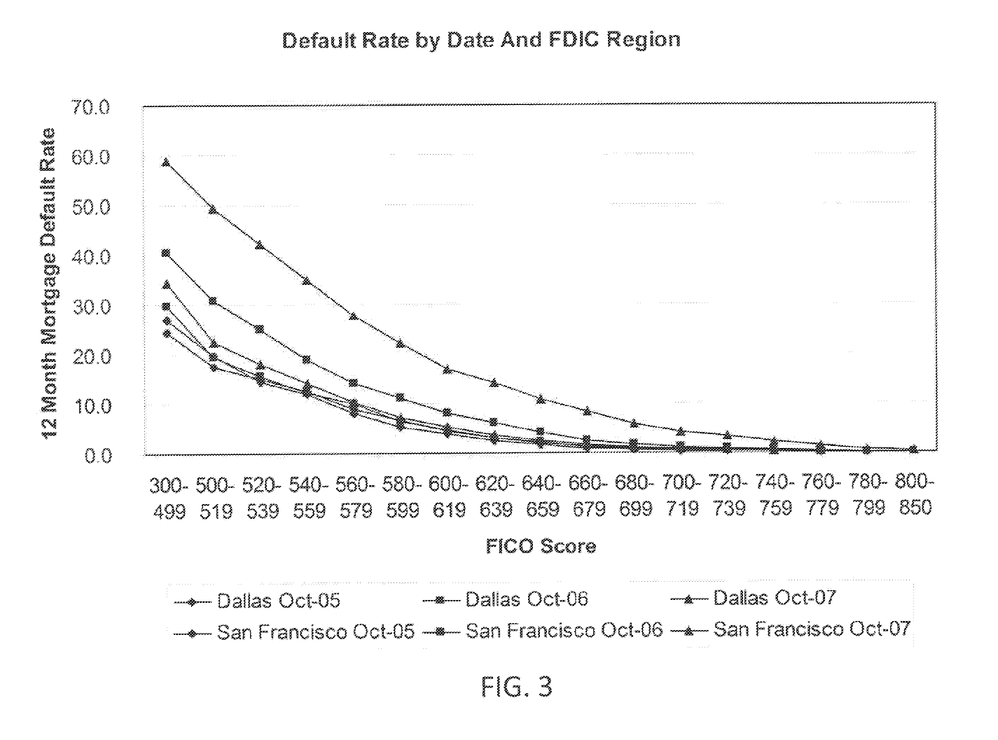

FIG. 3 illustrates mortgage default rates by date and by region. As shown, the differences illustrated in FIG. 2 are amplified when specific geographic regions are considered. This amplification is the basis for the cross-sectional approach described herein. For example, the differences shown in FIG. 2 can be further amplified by comparing data from the Dallas Federal Reserve District and data from the San Francisco Federal Reserve District. The San Francisco district includes the areas of San Francisco, Phoenix, Los Angeles, and Las Vegas, all of which can be seeing intense mortgage speculation and high escalation of home prices, and all of which can be experiencing fairly severe economic conditions. In contrast, some reports indicate that the Dallas Federal Reserve District, which is dominated by the Dallas and Houston metropolitan areas, are experiencing less house speculation and economy is relatively strong.

### Forward Looking Scores

As lenders can desire specific assessments of risk at every point in time, it can be advantageous for the risk tools to not only provide a rank ordering of risk over time, but also provide specific estimate of default risk for each score based on the current and forecast macroeconomic conditions at the time of scoring.

Since default risk can be influenced by the many factors noted above, risk tools can take into consideration the influence of credit policies and external influences on scores and default risk.

Below is illustrated one implementation that captures how scores and default rates can change as a factor of economic conditions, framed in terms of the credit-scoring industry. This implementation is best understood by first noting that there is a clearer relationship between score and risk when looking at risk in terms of “default odds,” (also sometimes to simply as “odds”) rather than “default rate” (also sometimes referred to simply as “rate”). The “default rate” and “default odds” have been defined below.

$$Default Rate = \frac{\# bad}{\# good + \# bad}$$

$$Default Odds = \frac{\# good}{\# bad} .$$

The definition of good and bad are contextual in that they are dependent on the decision problem at hand. In lending, for example, a “good” could be defined as someone who did not have delinquencies greater than N months on their loan during a given time window, whereas a “bad” could be defined as those who did have such delinquencies. The Odds for any given population of one or more customers can be measured as [(number of consumers demonstrating a good outcome)/(number of consumers demonstrating a bad outcome)].

Note that it is easy to translate backwards and forwards between default rate and default odds:

$$Default Rate = \frac{1}{1 + Default Odds}$$

$$Default Odds = \frac{1 - Default Rate}{Default Rate}$$

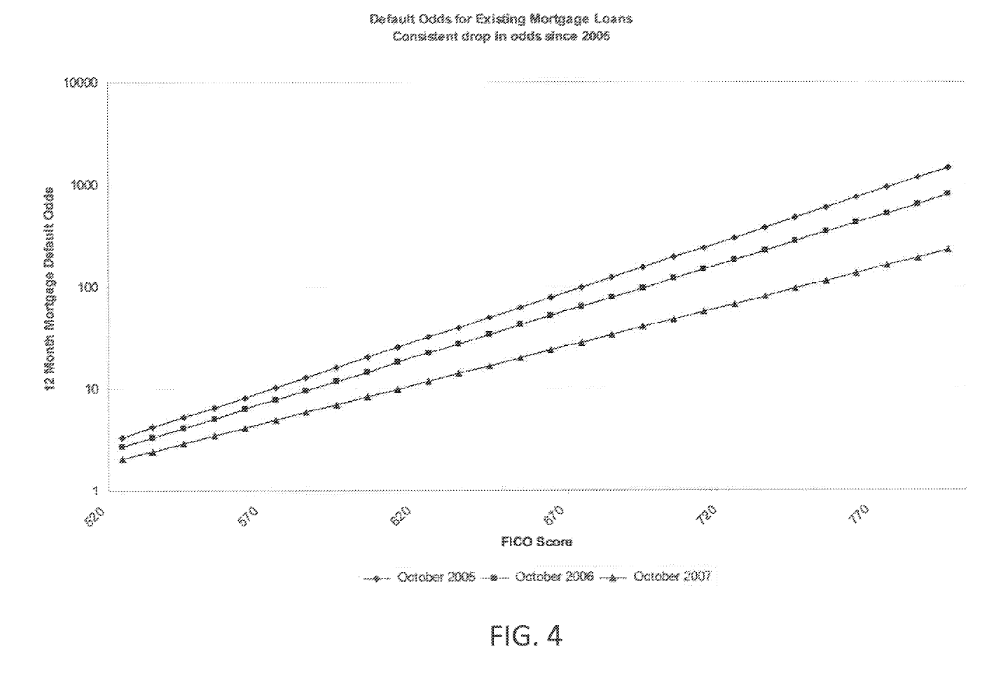

FIG. 4 illustrates a linear relationship between the natural logarithm of default odds and score. At each point in time “t” the relationship between natural logarithm of odds and score can be a standard slope-intercept relationship, such as:

ln (odds)=m*score+k

According to these scoring algorithms, the natural logarithm of the odds (ln (odds)) of a particular outcome can be approximately related to the score by a linear relationship. Odds can be thought of as a transformation of the probability of a particular outcome (such as paying back a loan). In that sense, odds and probability are related by formulas that can translate back and forth between each other as shown above. Odds relate to score in that one can refer to a specific score as having certain odds if the odds are measured as provided above as applied to only customers that have that specific score. Thus scores can be related to a probability of an outcome via the log-linear relationship of the score to odds, and the relationship of odds to probabilities as shown above. As will be explained below, sometimes odds must be measured by grouping multiple score values together into “bins” or “scorebands”

In one implementation, a logarithm of odds with any base number can be used instead of using a natural logarithm of odds. In the above equation for the linear relationship, “m” is the slope of the equation, and “k” is the axis-intercept associated with the equation. “m” and “k” are linear fitting parameters which can be obtained from any standard line-fitting algorithm—they represent the slope and intercept, respectively, of the line-of-best-fit that relates odds to scores. The reason for approximating the odds-to-score relationship via a linear equation is that it then becomes tractable to predict how these two quantities will vary (over time and across regions) as functions of economic variables.

A linear relationship is also practical because many model-training technologies (logistic regression, neural nets, scorecard technology, etc) are designed such that most cases will yield approximately a linear relationship between the log of odds and scores.

If a scoring algorithm, such as that noted above, produces hundreds of unique score values, it can be difficult to obtain a statistically robust measure for ln (odds) at every single unique score value, because the number of customers associated with any one score value can be very low relative to the full population. In such situations, it can be sometimes desirable to group the score range into multiple subsets (also referred to as “bins” or “scorebands”), which contain enough counts to yield statistically robust ln (odds) estimates. One approach is to divide the score range at every 5^{th} or 10^{th} percentile, and calculate the average score and ln (odds) by calculating ln [(# good)/(# bad))] within each bin (or scoreband). From there, a line can be fit through the ln (odds) versus average score data points, thereby yielding estimates for the linear parameters “m” and “k” of the linear relationship noted above.

When a score is developed, the score designer can scale the score to an initial odds to score relationship. The initial relationship chosen can be arbitrary, and thus the score can be scaled initially to meet some desired criteria, such as having an odds of 20:1 at a score of 600 and for 20 score points to double the odds. The initial m and k are chosen based on these desired criteria.

However, decision-makers using a scoring algorithm can find that this linear relationship between log-odds and score values can change significantly over time. As discussed above, this change can be caused by a number of factors, such as policies adopted by the decision-maker, the policies adopted by competitors of the decision-maker, and political, behavioral, and/or economic changes affecting market environment of the decision-maker. The market environment of the decision-maker (i.e., the external environment—for example, anything that can affect how a decision-maker's customers or competitors behave and/or regulatory/legal restrictions, etc.) refers to loan-payback environment, based on which the decision maker can vary terms and conditions associated with a loan, the change in terms and conditions including offer or refusal of the loan. Although the above-noted linear relationship simplifies the process of producing business forecasts and reduces uncertainty, the linear relationship may change over time. Thus, it can be desirable to obtain a deterministic formula to transform an original score into a score that has the same ln (odds) to score relationship as it did at any given point where it was used in the past. It is noted that “Original” can refer to any pre-existing score.

A forward-looking approach can be followed to predict changes in the ln (odds) to score relationship, wherein the changes can be caused due to economic factors, as noted below. The prediction of changes can be enabled by a statistical model that can model the ln (odds) to score relationship as a function of economic variables. These economic variables can include economic indicators, such as gross domestic product, unemployment, inflation, interest rates, real estate prices, and the like, which can be taken individually or in a combination. Past (historical) economic values, current economic values and predictive economic forecasts, taken either individually or in combination, can be used to make these predictions.

A model can be built to relate the slope and intercept in this equation to economic factors. So, given some projection of the economy (\vec{e}) in the future, odds associated with a score can be calculated as:

ln (odds)=m(\vec{e})*score+k(\vec{e})

Here, m(\vec{e}) is a model giving the slope under the economic conditions \vec{e}, and k(\vec{e}) is a model for intercept under the economic conditions \vec{e}. With such a relationship, lenders can now relate the impact of economic factors on odds, default rates and scores. Note that log(odds) and ln (odds) can been used interchangeably. Both terms represent an interchangeable variation of a same implementation.

Another implementation of this approach is to obtain a new score which has a stable odds to score relationship. With a desired stable slope m₀ and stable intercept k₀, a new score can be created as a function of the existing score:

newScore=(m(e)/mₒ)*existingScore+(k(e)−k₀)/m₀

Here, m(e) refers to the same quantity m(e) as discussed in the paragraph above, the slope predicted by the cross-sectional model, as a function of economic conditions. Similarly, k(e) represents the predicted intercept as a function of economic conditions. This transformation yields a score that has an odds-to-score relationship that stays approximately constant over time

One example of an implementation of this approach is described by U.S. patent application Ser. No. 12/275,017 filed on Nov. 20, 2008, the disclosure of which is hereby incorporated by reference in its entirety.

The above-noted predictions can be made as follows. Each time point in the past, when an outcome is available, can correspond to a respective ln (odds) to score relationship. The slope (“m”) and intercept (“k”) of the respective ln (odds) to score relationships can be measured at each time point. These values of slope (“m”) and intercept (“k”) can be transformed into de-correlated variables rotation (kappa) and translation (tau). Data associated with these “past available outcomes” (or “performance”) can be combined with observed economic variables from the past, the observed economic variables being used as predictors. Next, two time series models can be built, based on any standard time-series regression technique, such as linear regression, auto-regression, auto-regressive integrated moving average (ARIMA), and the like. These two time series models include a first model to predict rotation (kappa) as a function of economic variables, and a second model to predict translation (tau) as a function of economic variables.

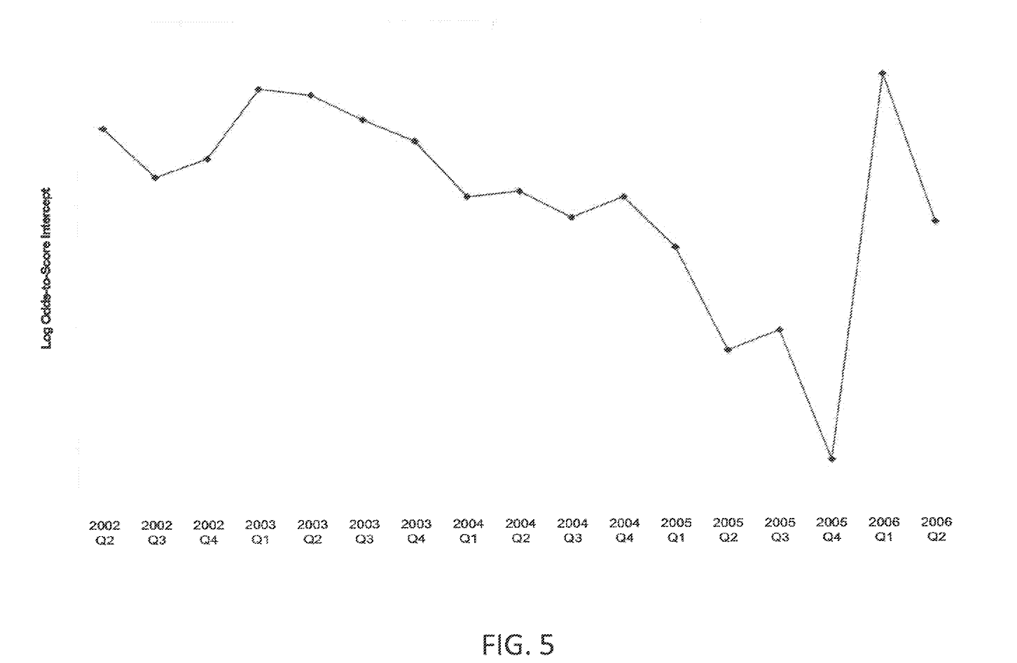

FIG. 5 illustrates variation of the intercept “k” (intercept of the ln (odds) to score relationship, as noted above) over time with respect to a particular score.

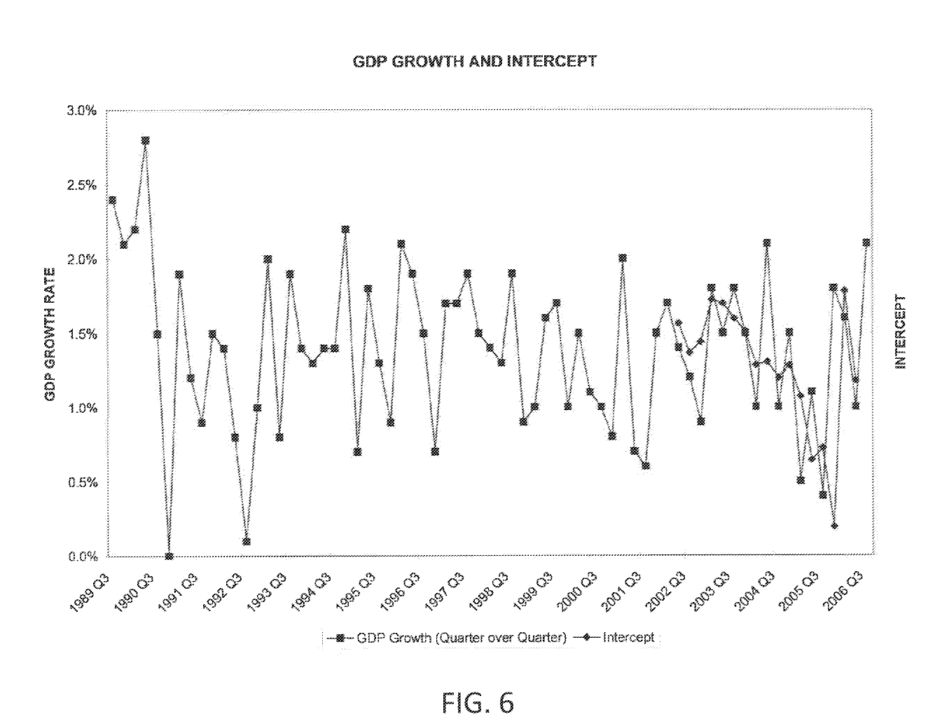

FIG. 6 illustrates a relationship between economic factors (GDP growth rate) and the intercept “k” (intercept of the ln (odds) to score relationship, as noted above) over time.

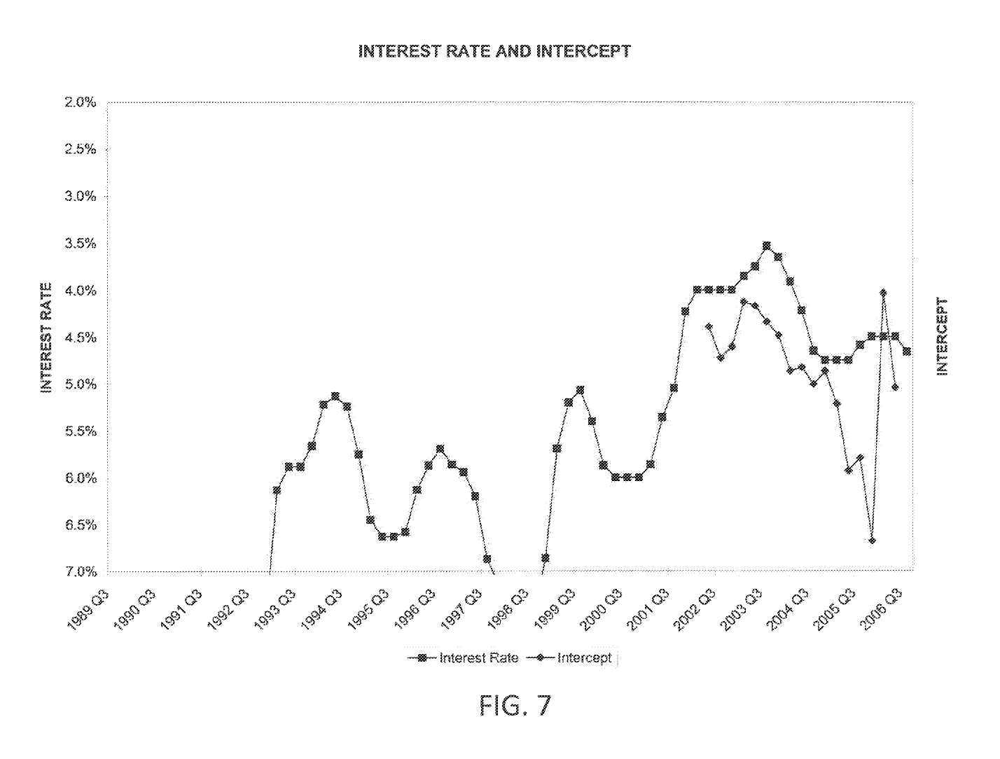

FIG. 7 illustrates a relationship between economic factors (Interest rate) and the intercept “k” (intercept of the ln (odds) to score relationship, as noted above) over time. The interest rate can be the prime lending rate. Note that the interest rate axis in FIG. 7 is flipped. Thus, the correlation between the intercept and fluctuations in interest rates is shown.

The correlations between the intercept and key macroeconomic indicators, as discussed above, enables building models that relate economic indicators to slope and intercept of the equation relating ln (odds) to score.

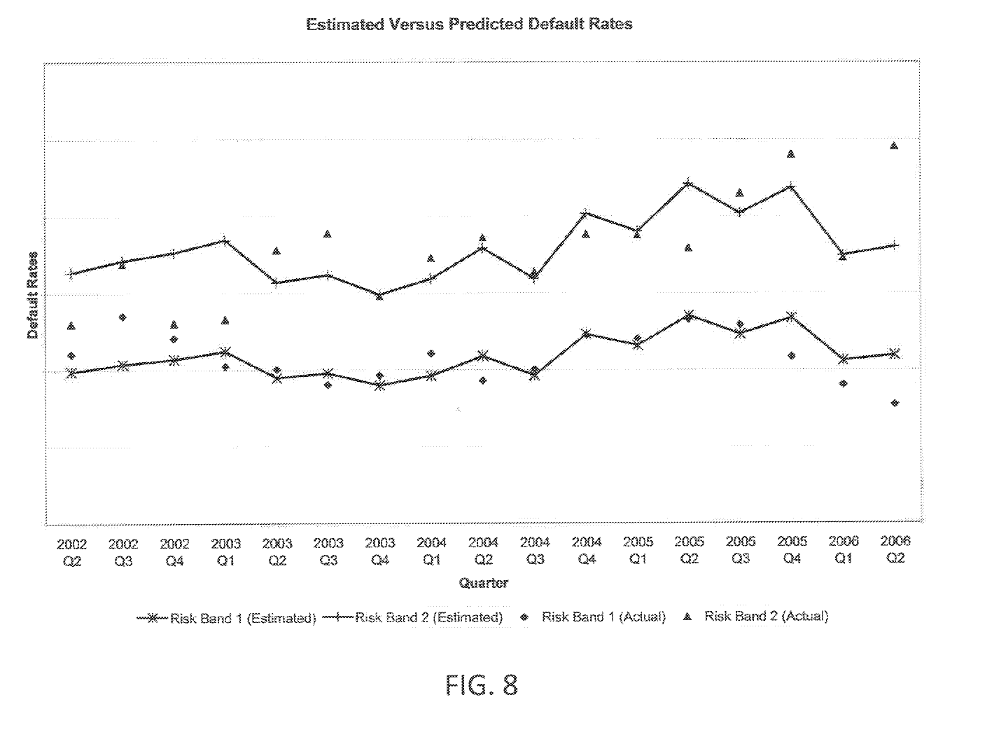

FIG. 8 illustrates prediction of the risk within each scoreband at various given points in time, the prediction reflecting the changes to the risk of the scoreband based on macroeconomic conditions, enabled by these built models.

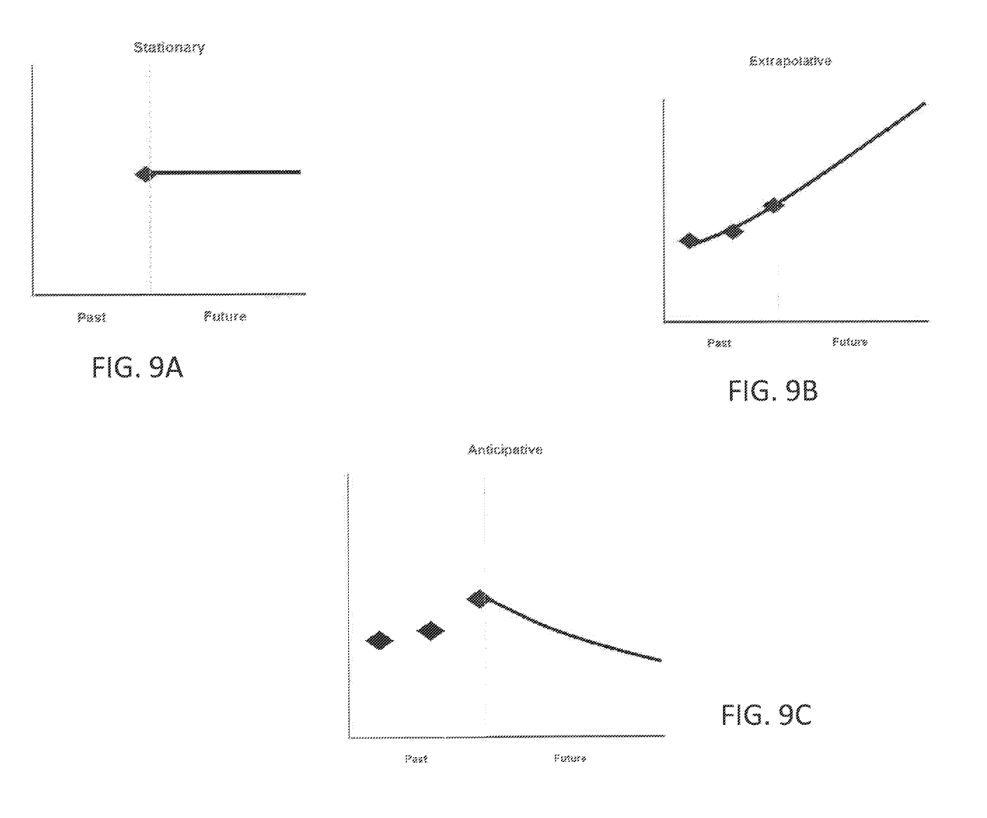

To generate predictions of default rate, one first needs statistics describing the current economic conditions, or forecasts of the economic conditions. There are three primary ways to estimate the future economy. The first is shown in FIG. 9A, which assumes a constant economic behavior. Alternatively, it can be assumed that the economy will continue on its current path, as shown, for example, in FIG. 9B. A third possibility is to assume that the economy will change its current path, as shown, for example, in FIG. 9C. Other economic projections, such as sophisticated economic projections provided by Moody's or an internal risk team, may also be used as inputs to the model.

To avoid modeling certain correlations between changes in the slope and in the intercept, statistical models are built to predict factors relating to slope and intercept instead of the slope and intercept directly. These factors can then be translated into the slope and intercept. This will be described in more detail below.

A “constant-over-time” model (i.e., a model that does not depend on economic factors and hence does not produce varying predictions over time, etc.) can be substituted for either rotation or translation, wherein the model's prediction of either rotation or translation remains fixed over time and remains independent of economic variables. The point is that either rotation or translation can be modeled as being independent of economic variables, but as long as at least one of rotation and translation is modeled based on economic factors, together the combination of rotation and translation still defines an odds-to-score relationship that is dependent on economic factors.

### Model Variation by Product Type

As discussed above, the relationship between risk and score can vary differently for different types of loans and different products. For different products, different key economic indicators can be important variables in these models. Thus different models may need to be built to relate the changes in macroeconomic factors to the slope and intercept for different loans and products.

For instance, consumers, who obtain ARM mortgages with the intention of refinancing the house before the ARM expires, can find it difficult to refinance if the value of their house has dropped over time. Thus, ARMs can be more sensitive than other types of loans to the macroeconomic factor of the Home Price Index (HPI). Conventional mortgages can be more sensitive to more standard economic indicators, such as unemployment levels.

### Applying the Technology

Once the economic modeling has been performed on each loan type, this technology can be applied in a variety of areas.

However, before using this technology, it can be necessary to forecast future economic conditions. The projections of risk can be highly sensitive to these economic projections.

Given an economic forecast, there are many potential applications for this forward looking odds technology to, adjust both risk estimates of the existing book, as well as the strategy in the future.

Some implementations may include creating economically adjusted strategies. This can be useful in many applications, and some examples of which will be discussed below.

### Application: Account Acquisitions.

When making acquisition decisions, a simple approach can be to pick a “cut-off score”, accepting accounts above the score and rejecting accounts below the score. Fundamentally, what the bank can do is choose an acceptable risk level, and accept accounts that meet the risk criteria.

This can be done by, for example, picking a fixed cut-off score. A forward-looking score approach may also be used, e.g. a bank can estimate what the odds associated with a score will be in the future, and pick the cut-off score based on the expected future odds, as opposed to the historical odds. This way, the bank can maintain the desired risk in the portfolio and maintain the cut-off score at a fixed level as the economy changes.

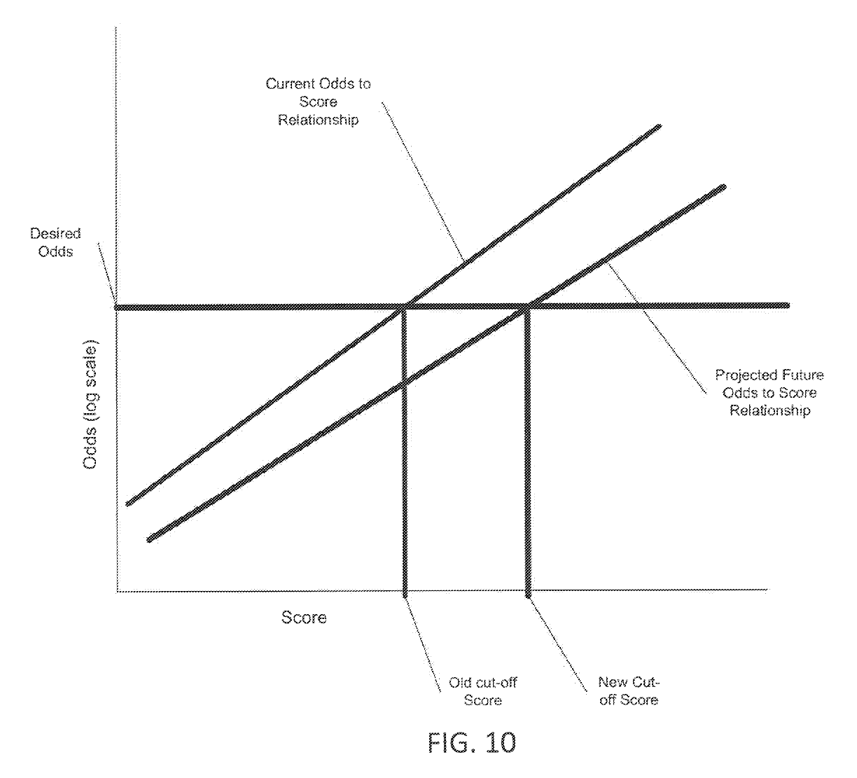

FIG. 10 illustrates how lenders/banks can set the new cut-off score. The cut-off score can be modified to maintain constant odds. Mathematically, the cut-off score is changed as follows:

$$new cutoff = \frac{{m}_{0}}{m ( \vec{e} )} \cdot ( old cutoff ) - \frac{k ( \vec{e} ) - {k}_{0}}{m ( \vec{e} )}$$

where m₀ and k₀ is the observed historical slope and intercept, and m(\vec{e}) and k(\vec{e}) are the modeled slope and intercept under the projected economic conditions \vec{e}.

### Application: Loan Modification

The lenders can examine their own portfolios to understand which loans should be modified, such as lowering the interest rate or forgiving debt on an underwater mortgage. The goal can be a win-win situation, in which the consumer may not lose an asset, such as home, and the bank can avoid spending time and money associated with the foreclosure process.

There are many variables that the bank can consider when making the decision as to whether or not to modify a loan. For example, one key variable can be the expected default rate under the existing and modified loan structure. Other important variables include, for example, estimates of the potential gain or loss to the bank under the old and new loan terms, as well as the cost to the lender to modify the loan.

The exact formation of the financial model to evaluate the benefit to the lender of modifying a loan can be complicated, and the details can be frequently debated within lending institutions.

However, historical experience demonstrates that these kinds of models can be extremely sensitive to the default rate expectation. As such, obtaining precise estimates of the default rate for these loans under expected future economic conditions can be critical for banks to make the best decision on how to modify loans.

### Application: Setting Capital Reserve Levels

To set capital reserves for a portfolio properly, it is important to understand what the risk in the portfolio is under stressed economic conditions. This is explicitly part of the Basel II regulations, but can generally be a part of “best practice” risk management as well.

A portfolio manager can choose the macroeconomic conditions that the portfolio manager wishes to consider for the stressed scenario, and use that to obtain an odds-to-score relationship under those conditions. That can then be used to estimate the risk for each loan in the portfolio under those conditions. This account-level risk can then be “rolled up” to obtain an estimate for the portfolio level risk under the stressed economic circumstances, which can be used to help set reserve levels.

### Application: Portfolio Quality Evaluation

Similar to capital reserve setting, a portfolio manager can identify some reasonable, non-stressed future economic conditions, and can evaluate the risk in the portfolio under those conditions. This evaluation can help to understand the current quality of the portfolio and to give better estimates of future risk and profitability to bank management and shareholders.

Thus, it is critical for banks to understand how the risk in their portfolio can change due to economic circumstances. It is also critical to understand, however, that different sub-portfolios can have different overall risk levels, and the risk associated with a particular score can be different for different portfolios. A portfolio manager can obtain these risk estimates using the cross-sectional model provided herein.

### Cross-Sectional Model

To create the models that relate economic factors to the rotation and translation require data where both the economic factors and the odds to score relationship change. One approach is to collect several years worth of data, where the economic conditions will change over time, as will the odds to score relationship. The “pure time-series” approach models can require at least one economic cycle of data, which can be approximately seven to ten years worth of data. Collecting such large amount of data can be costly, and sometimes it is not even available. Accordingly, it can be advantageous to obtain a model that does not include the “pure time-series” approach. Further, as lender or competitive actions can change over time, and these changes can be difficult if not impossible to quantify, it can be advantageous to obtain a model that is not impacted by policy changes. Furthermore, it can be advantageous to have a model that is associated with relatively less data, thereby lowering costs, as opposed to high costs associated with storage of huge amounts of data.

Such a model that provides advantages, including those noted above, is a cross-sectional model. The cross-sectional model leverages the economic variation across distinct economic entities in relatively few time periods, as few as one time period. The distinct economic entities can include different regional divisions, such as countries, states, counties, metropolitan statistical areas (MSAs), cities, and the like. The term “cross-sectional” arises from the fact that modeling is performed for different regions (i.e., cross-sections). A “pure time-series” approach creates models based on the correlation of economic indicators (e.g. unemployment) with the log odds to score relationships based on how economic data and odds to score relationships correlate across time; whereas the cross-sectional approach creates models based on the correlation of economic indicators (e.g. unemployment) and the log odds to score relationship based on how the economic data and odds to score relationship correlate between regions. In choosing a set of regional divisions to be used for the cross-sectional approach, an important consideration is that past economic data, as well as past known outcomes, must be available for each region. If a modeler (i.e., the creator of a cross-sectional model, etc.) wishes to consider forecasted economic data (i.e., data from a date later than the date at which the score in question is calculated), an additional consideration can be availability of forecasts of the economic data for each region.

In the cross-sectional model, for example, within the United States, the most practical regional distinction may be to use state-level variations, because (1) government organizations and economic data providers typically collect and publish a large number of economic metrics at the state level; (2) statewide economies can show significant variation relative to one another (e.g., California/Nevada vs. Wyoming/Idaho vs. NY/Massachusetts). A modeler can then build a model to capture the relation across regions between economic conditions and the linear ln (odds) to score relationship.

### Building a Cross-Sectional Model

The examples noted below deal with modeling the translation component (tau) of the ln (odds) to score relationship. The same process can also be applied to generate models that predict rotation (kappa).

Table 1, shown below, describes one format in which data required for a cross-sectional model can generally be put.

TABLE 1

| | | | | Odds-to-Score |
|---|---|---|---|---|
| | | Economic data | | based on Known Past |
| | | (predictors) | | Outcomes |
| | | Economic | Economic | (to be predicted) |
| Date | Region | variable 1 | variable N | Translation |
| Date 1 | Region 1 | 0.232 | 0.248 | 0.014 |
| Date 1 | . . . | . . . | . . . | . . . |
| Date 1 | Region M | . . . | . . . | . . . |
| . . . | Region 1 | . . . | . . . | . . . |
| . . . | . . . | . . . | . . . | . . . |
| . . . | Region M | . . . | . . . | . . . |
| Date T_Max | Region 1 | . . . | . . . | . . . |
| Date T_Max | . . . | . . . | . . . | . . . |
| Date T_Max | Region M | 0.881 | 0.701 | 0.622 |

The economic variables can either be retrieved directly from available economic data sources such that the “raw” economic variables are used as economic variables, or the economic variables can be derived, using deterministic formulas, from such “raw” variables. Using deterministic formulas includes using the percentage growth year-over-year for a variable such as Gross Domestic Product. The economic variables can also involve a simple “lag” transformation of the “raw” economic variables. For example, economic data from sometime before or after a given date can be used to predict the performance associated with that date. If an economic variable is not available for a particular combination of date and region, then the corresponding row can be omitted in Table 1.

Once Table 1 is constructed, any standard statistical modeling technique can be used to build a model predicting, based on the economic predictor variables, a target column. In Table 1, the translation component of the relationship between odds and score is the target column, wherein the translation component is predicted based on the economic predictor variables. The modeling technique can be as simple as least-squares linear regression, but more complex time-series techniques (e.g., auto-regressive, moving average, and the like) can also be applied. Note that the addition of a regional dimension to Table 1 can introduce the possibility of using panel regression, which can be considered when choosing a modeling technique. That is, a panel regression can optionally create models where some, all, or none of the coefficients are shared, and therefore simultaneously optimized, across regions.

Table 2 shown below illustrates examples of different panel regression structures, for the simplest case of least-squares linear regression.

TABLE 2

| Model type | Model structure |
|---|---|
| Pooled model | Prediction(region r, date t) = |
| | intercept + coeff1*econVar 1(r,t) + . . . + |
| | coeffN*econVarN(r,t) |
| Fixed-effect | Prediction(region r,date t) = |
| model | intercept(r) + coeff1*econVar 1(r,t) + . . . + |
| | coeffN*econVarN(r,t) |
| Variable- | Prediction(region r, date t) = |
| coefficient model | intercept(r) + coeff1(r)*econVar 1(r,t) + . . . + |
| | coeffN(r)*econVarN(r,t) |

These examples illustrated in Table 2 are discussed more explicitly below, in context of linear regression. (1) a pooled model uses same intercept and economic coefficients for each region, (2) a fixed-effect model uses same economic coefficients for each region, but allows the intercepts to vary by region, and (3) a variable-coefficient model allows intercepts and economic coefficients to vary by region. As the variable coefficient model results in a so-called “partitioned regression” structure, the variable coefficient model is mathematically equivalent to building a separate model independently on each region. The more coefficients that need to be estimated, the more data is required. Therefore, to minimize the amount of data used by the cross-sectional model, a pooled model can be the best option if time-series data is limited, followed by the fixed-effect model, and then last is the variable-coefficient model.

As mentioned above, the same modeling process is applied to both rotation and translation, but different economic predictor variables can be selected for the two models, because the economic variables that are most predictive in a rotation model may not end up being the variables that are most predictive for translation.

### Applying/Deploying a Cross-Sectional Model

In some implementations, a system takes the cross-sectional model associating econometric data and subsequent outcomes, and applies the cross-sectional model using regional data, which can be either national economic data or state-level economic data. To apply a cross-sectional model using national economic data, national economic data can be used as an input to the model even if regional data is used to train the model. On the other hand, if the model is to be deployed using state-level data, then the deployment system must feed a customer's state/region of residence, or perhaps the state/region in which a given transaction occurred, into the scoring subsystem, so that the cross-sectional model can consider the economic data relevant to that region.

Thus, this modeling approach can effectively capture shifting economies over time. This modeling approach can be much more practical as compared to the much more expensive time-series approach. Further, this modeling is termed as cross-sectional modeling, as the modeling is not based on time-series dimension.

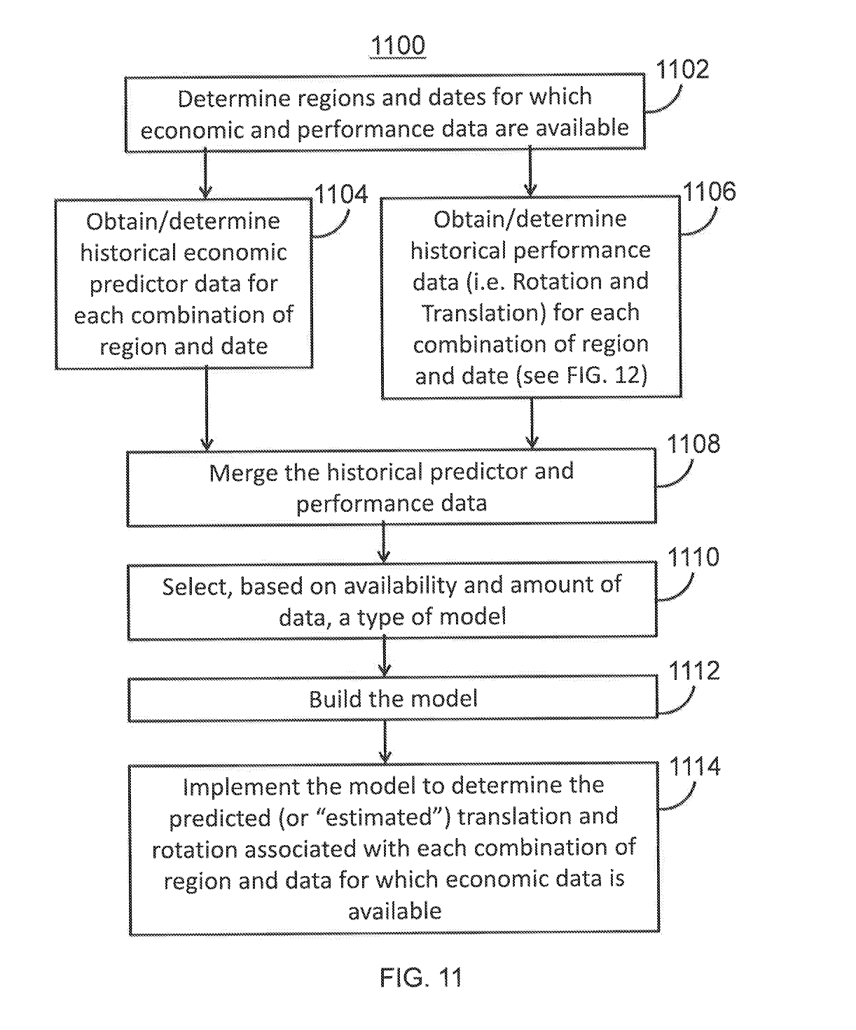

FIG. 11 is a flowchart 1100 illustrating a method consistent with some implementations of the current subject matter.

At 1102, regions and dates, for which economic data is available, can be determined, as shown in Table 1. The regions can include different countries, states, counties, metropolitan statistical areas (MSAs), cities, and the like. Different regions are determined such that the cross-sectional model, as is determined later, indicates how an economic indicator (e.g. unemployment) in a first region correlates with account data at a first time as compared to how economic indicator (e.g. unemployment) in a second region correlates with account data at a same first time. For example, see Table 1.

At 1104, economic data can be obtained for each combination of region and time, as shown in Table 1. For example, see Table 1. The economic data can include economic indicators, such as gross domestic product, unemployment, inflation, interest rates, real estate prices, and the which can be taken individually or in a combination. Past (historical) economic values, current economic values and predictive economic forecasts, taken either individually or in combination, can be used to make these predictions. In the above, use of economic data (which affects the loan-payback ability of a customer) is exemplary. In other implementations, instead of merely economic data, other variables affecting the payback capability of a customer can be used, such as political data, natural calamity data, behavioral data, data associated with changes in legal and regulatory environment, and the like. Once this data is collected, modeling can be performed to model this collected data.

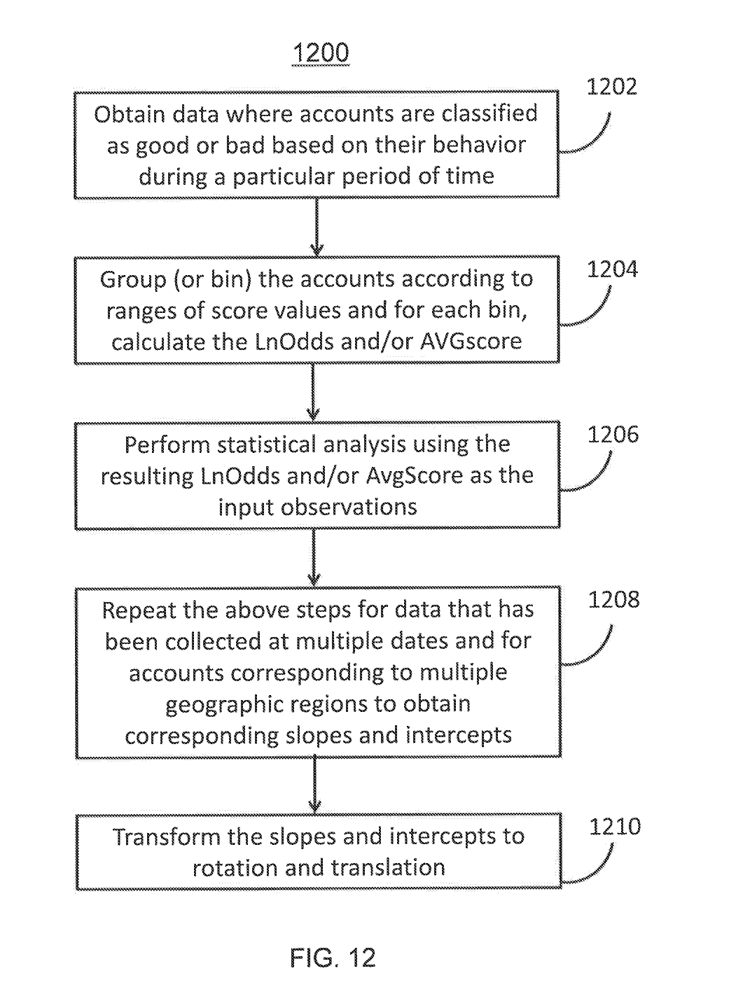

At 1106, obtain in each region at each point in time, the odds to score relationship of the score within this region, and obtain a slope and intercept of the odds to score relationship within each region at each point in time, and then converting the slope and intercept into translational and rotational coefficients, according to the procedure outlined in FIG. 12.

At 1202, obtain data where accounts (e.g. consumers) are classified as “good” or bad” based on their behavior during a particular period of time (e.g. a “performance window”). For example, a lender might decide that all accounts that are less than 30 days past due are “good”, that all accounts that are 90 or more days past due are “bad”, and that all others are “indeterminate” (and should be excluded from the remainder of the process). The credit score for each account (or consumer) is calculated based on whatever historical credit information would have been available at the beginning of the performance window.

At 1204, Group (or “bin”) the accounts according to ranges of score values (e.g. if 20 bins are desired, then the accounts can be grouped into: lowest-scoring 5%, 2^{nd}-lowest scoring 5%, etc. . . . ), and calculate LnOdds in each bin and AvgScore (average score) in each bin.

At 1206, perform a statistical analysis (e.g. weighted least squares regression) using the resulting list of (AvgScore, LnOdds) as the input observations, with the weight determined by the total # of accounts (or consumers) falling into each bin. A weighted least squares regression will provide estimates for the slope “m” and intercept “k”.

At 1208, this process can be repeated for data that has been collected at multiple dates (i.e. over multiple “performance windows”) and for accounts/consumers corresponding to multiple geographic regions. At this point, the slopes and intercepts corresponding to multiple dates and regions will be obtained.

At 1210, the slope and intercept are transformed into Rotation and Translation, which are decorrelated.

To convert the slope and intercept into “translational” and “rotational” components:

1. Take all observed slopes and compute their average and standard deviation (yielding slope_mean and slope_stdev).

2. Take all observed intercepts and compute their average and standard deviation (yielding intercept_mean and intercept_stdev).

3. For each (slope, intercept) pair, convert it into a (rotation, translation) pair according to the following formulas:

Rotation=(slope−slope_mean)/slope_stdev.

Translation=Rotation+(intercept−intercept_mean)/intercept_stdev

This data can be merged with the predictive data (usually macroeconomic data) to form a “modeling dataset” (i.e., a dataset that contains both the performance data [rotation/translation] and the predictor [typically macroeconomic] data).

It is noted that Slope and intercept are typically observed to be very strongly correlated. The goal of creating “rotation” and “translation” by standardizing slope and intercept is to create two uncorrelated variables, such that the models can be used in conjunction without errors introduced due to correlations between the models.

Coming back to FIG. 11, at 1108, historical predictor obtained at 1104 and the performance data obtained at 1106 are merged. At 1110, the modeling of the rotational or translational component using the collected economic data can be performed based on availability of amount of data. At 1112, the model is built. The modeling can be performed by using one or more techniques, such as least-squares linear regression, auto-regressive technique, moving average technique, and other statistical techniques. Different models can be implemented based on the amount of available data, the models including a pooled model, a fixed-effect model, and a variable-coefficient model, as noted above with respect to Table 2. To minimize the amount of data used by the cross-sectional model, a pooled model can be the best option if time-series data is limited, followed by the fixed-effect model, and further followed by the variable-coefficient model.

At 1114, the model can be implemented to determine a translation component associated with each combination of region and date for which economic data is available. Similarly, the model can be implemented to determine a rotation component associated with the each combination of region and date.

The translational and rotational components can then be translated back into a slope and intercept, using the inverse of the above equations. The equations for rotation and translation can be inverted as follows:

slope=Rotation*slope_stdev+slope_mean

intercept=(Translation−Rotation)*intercept_stdev+intercept_mean

These equations are useful for transforming predictions of rotation and translation (which are produced by the time-series models described above) into predictions of slope and intercept.

It is noted that the predicted log odds depends on the value of the score, the predicted slope, and the predicted intercept. The slope is a function of the rotation. The intercept is a function of the rotation and the translation. (These functions arise from inverting the formulas for Rotation and Translation as functions of Slope and Intercept as discussed above). The predicted rotation and translation are a function of the economy. For example, these relationships may be expressed as follows:

PredictedLnOdds=m(kappa(\vec{e})*Score+k(kappa(\vec{e}),tau(\vec{e}))

Where
k=intercept
m=slope
e=economic predictors
kappa=Rotation
tau=Translation

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flows depicted in the accompanying figures and described herein do not require the particular order shown, or sequential order, to achieve desirable results. Other embodiments may be within the scope of the following claim.

What is claimed is:

1. A computer-implemented method of predicting a risk indicator that is stable over time, the method being implemented by one or more data processors and comprising:
receiving, by at least one data processor, data representing a credit risk score and a credit report, the credit report comprising a plurality of prediction characteristics used to determine creditworthiness of an individual;
inputting, by at least one data processor to a predictive model, the received data; the predictive model being generated by
storing available historical data for combinations of a plurality of regions and dates, the available historical data comprising macroeconomic data and credit performance data;
building the model based on the available historical data; and
determining a translation and/or rotation of the predictive model associated with the combinations of the regions and dates based on the built model;
outputting, by at least one data processor, from the predictive model based on the received data, a risk indicator.

2. A method according to claim 1, further comprising:
adjusting, by at least one data processor, the predictive model using selected economic data from the available historical data and determining a new translation and/or rotation of the predictive model associated with the selected economic data.

3. A method according to claim 1, further comprising adjusting the risk indicator based on the one or more factors selected from the group comprising: a type of loan, one or more marketing policies, one or more underwriting criteria, a portfolio sourcing, a customer sourcing, one or more collection practices, a competition, geography, and the economy.

4. A method according to claim 1, wherein the risk indicator outputted by the predictive model is:
ln (odds)=m(\vec{e})*score+k(\vec{e})
where m(\vec{e}) is a model giving the rotation (slope) under economic conditions \vec{e}, and k(\vec{e}) is a model for translation (intercept) under the economic conditions \vec{e}.

5. A method according to claim 1 wherein the predictive model is:
newScore=(m(e)/m₀)*existingScore+(k(e)−k₀)/m₀
where m(\vec{e}) is a model giving the rotation (slope) under economic conditions \vec{e}, and k(\vec{e}) is a model for translation (intercept) under the economic conditions \vec{e}, and newScore is the risk indicator having a constant odds to score relationship.

6. A method according to claim 1, further comprising deciding, by at least one data processor, whether the risk indicator meets a minimum requirement.

7. A method according to claim 1, wherein building the model comprises using least-squares linear regression or time-series techniques.

8. A method according to claim 1, further comprising inputting to the predictive model, a risk region of the risk being assessed, wherein the risk indicator outputted by the predictive model is based on the available economic data relevant to the risk region.

9. A computer-implemented method of generating and implementing a model to predict changes in a relationship between a credit score and subsequent observed outcomes, the method being implemented by one or more data processors and comprising:
storing available historical data for combinations of a plurality of regions and dates, the available historical data comprising macroeconomic data and credit performance data;
building the model based on the available historical data; and
determining a translation and/or rotation of the predictive model associated with the combinations of the regions and dates based on the built model.

10. A method according to claim 9, further comprising:
adjusting, by at least one data processor, the predictive model using selected economic data from the available historical data and determining a new translation and/or rotation of the predictive model associated with the selected economic data.

11. A method according to claim 9, wherein the predictive model is:
ln (odds)=m(\vec{e})*score+k(\vec{e})
where m(\vec{e}) is a model giving the rotation (slope) under economic conditions \vec{e}, and k(\vec{e}) is a model for translation (intercept) under the economic conditions \vec{e}.

12. A method according to claim 9 wherein the predictive model is:
newScore=(m(e)/m₀)*existingScore+(k(e)−k₀)/m₀
where m(\vec{e}) is a model giving the rotation (slope) under economic conditions \vec{e}, and k(\vec{e}) is a model for translation (intercept) under the economic conditions \vec{e}, and newScore is a risk indicator having a constant odds to score relationship.

13. A method according to claim 9, wherein the translation and/or rotation of the predictive model are substantially stable across the combinations of the regions and dates.

14. A method according to claim 9, wherein building the model comprises using least-squares linear regression or time-series techniques.

15. A system for producing a risk indicator that is stable over time, the system comprising: a computing device, said computing device comprising a processing component and a storage component; and computer-readable instructions residing in said storage component which, when executed by said processing component instruct said processor to perform operations comprising:
receiving data representing a credit risk score and a credit report, the credit report comprising a plurality of prediction characteristics used to determine creditworthiness of an individual;
inputting to a predictive model the received data; the predictive model being generated by
storing available historical data for combinations of a plurality of regions and dates, the available historical data comprising macroeconomic data and credit performance data;
building the model based on the available historical data; and
determining a translation and/or rotation of the predictive model associated with the combinations of the regions and dates based on the built model;
outputting from the predictive model based on the received data, a risk indicator.

16. A system according to claim 15, further comprising:
adjusting, by at least one data processor, the predictive model using selected economic data from the available historical data and determining a new translation and/or rotation of the predictive model associated with the selected economic data.

17. A system according to claim 15, further comprising adjusting the risk indicator based on the one or more factors selected from the group comprising: a type of loan, one or more marketing policies, one or more underwriting criteria, a portfolio sourcing, a customer sourcing, one or more collection practices, a competition, geography, and the economy.

18. A system according to claim 15, wherein the predictive model is:
ln (odds)=m(\vec{e})*score+k(\vec{e})
where m(\vec{e}) is a model giving the rotation (slope) under economic conditions \vec{e}, and k(\vec{e}) is a model for translation (intercept) under the economic conditions \vec{e}.

19. A system according to claim 15 wherein the predictive model is:
newScore=(m(e)/m₀)*existingScore+(k(e)−k₀)/m₀
where m(\vec{e}) is a model giving the rotation (slope) under economic conditions \vec{e}, and k(\vec{e}) is a model for translation (intercept) under the economic conditions \vec{e}, and newScore is the score with a constant odds to score relationship.

20. A system according to claim 14, further comprising inputting to the predictive model, a risk region of the risk being assessed, wherein the risk indicator outputted by the predictive model is based on the available economic data relevant to the risk region.
